(19) United States
(12) Patent Application Publication
(10) Pub. No.: US 2001/0032321 A1
(43) Pub. Date: Oct. 18, 2001

(54) Power Conservation for a Display Controller in Accordance with the State of Connection or of the Source Power Received by the Display Controller

(76) Inventors: NOBUYUKI NANNO, TOKYO (JP); YOSHIO MATSUOKA, TOKYO (JP)

Correspondence Address: FINNEGAN HENDERSON FARABOW GARRETT, & DUNNER, 1300 I STREET, N.W., WASHINGTON, DC, 200053315

(21) Appl. No.: 09/055,938

(22) Filed: Apr. 7, 1998

(30) Foreign Application Priority Data
Aug. 21, 1997 (JP) 9-225055

(51) Int. Cl. G06F 1/26; G06F 13/00; G06F 1/28; G06F 1/30

(52) U.S. Cl. 713/300; 710/101

(57) ABSTRACT

A CPU determines if an expansion unit is docked or if there is external power supplied, in accordance with an SMI signal received. When a personal computer is docked to an expansion unit or when supply of external power is initiated, a process for switching the display mode to a high performance display mode for carrying out image display with the optimal display performance available from a display controller is started. When the personal computer is undocked from the expansion unit or when supply of external power is inhibited, a process for switching the display mode to a low power display mode set in the display controller is started. In those mode switching processes, power supply to a VRAM, the setting of a work area and a clock rate are changed.

### BACKGROUND OF THE INVENTION

The present invention relates to a computer removable from an expansion unit for expanding functions, and, more particularly, to a computer, power supply to which is controllable in accordance with its docking state to an expansion unit.

This invention also relates to a computer operable in accordance with power from a built-in battery or externally supplied power, and, more particularly, to a computer, power supply to which can be controlled in accordance with whether or not power is externally supplied.

This application is based on Japanese Patent Application No. 9-225055, filed on Aug. 21, 1997, the contents of which are incorporated herein by reference.

Laptop type or notebook type portable computers which are easy to carry and are operable on battery power have been developed. Portable computers of this type are designed in such a way that an expansion unit for expanding functions can be docked to each computer.

The expansion unit includes a drive bay for attachment of a drive unit like a hard disk drive and expansion slots for attachment of various option cards. Docking a portable computer to the expansion unit can expand substantially the same functions as those of a desktop computer without loosing the portability of the portable computer.

Recent portable computers are strongly demanded of a longer battery-driven time when they are carried. To meet such a requirement, some portable computers are equipped with a power save function which, for example, decreases the CPU's processing speed (or slows the rate of the clock to be supplied to the CPU), thereby reducing power dissipation.

This power save function is however accomplished by considering only the processing speed or operation time of the CPU, and no consideration has been given to power consumption by other components of the computer. For example, image display is so set as to always implement the optimal display performance regardless of whether or not external power is supplied or the computer is docked to the expansion unit.

The display performance means (1) the number of display colors, (2) the physical screen size, and (3) the maximum horizontal and vertical sync frequencies of a display (LCD, CRT or the like). The factors (1) and (2) are determined essentially by the capacity of a VRAM (Video Random Access Memory), and the factor (3) essentially by the clock rate at the time the display controller operates the VRAM or display.

In other words, the conventional portable computers operate in such a manner that the display control system such as those VRAM and display controller keeps the best display performance irrespective of whether or not external power is supplied to the computer body or whether or not the computer body is docked to the expansion unit. Even when those portable computers are operating on the battery power, therefore, the display control system consumes a certain amount of power, which shortens the battery-driven time.

### BRIEF SUMMARY OF THE INVENTION

Accordingly, it is an object of the present invention to provide a computer whose battery-driven time can be increased by reducing power dissipation in accordance with its docking state to an expansion unit and/or whether or not external power is supplied.

According to the first aspect of this invention, there is provided a computer comprising: a display for displaying an image; detection means for detecting start and stop of supply of external power to the computer; and display control means for controlling image display on the display, a display performance of the display control means being altered in accordance with a result of detection by the detection means.

This invention controls the display performance or power supply to the display control system in accordance with the docking/removal of the computer to or from the expansion unit. This design lowers power dissipation when the computer is not docked to the expansion unit, and thus extends the drive time allowable by a battery alone.

According to the second aspect of this invention, there is provided a computer connectable to an expansion unit, comprising: a display for displaying an image; detection means for detecting docking and undocking the computer to and from the expansion unit; and display control means for controlling image display on the display, a display performance of the display control means being altered in accordance with a result of detection by the detection means.

This invention controls the display performance or power supply to the display control system in accordance with the initiation/inhibition of external power supply to the computer. This structure reduces power dissipation when no external power is supplied to the computer, and thus extends the drive time allowable by a battery alone.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the structures of a computer body (personal computer) according to a first embodiment of this invention and an expansion unit (docking station) connectable to this computer body;

FIGS. 2A and 2B are perspective views illustrating the outline of the expansion unit shown in FIG. 1 and how the computer body is docked to the expansion unit;

FIG. 3 is a block diagram depicting the structure of an expansion unit (card dock) connectable to the computer body shown in FIG. 1;

FIGS. 4A and 4B are perspective views showing the outline of the card dock shown in FIG. 3;

FIG. 5 is a flowchart for explaining the operation of a power save function according to the first embodiment;

FIG. 6 is a flowchart for explaining the operation of a power save function according to a second embodiment of this invention; and

FIG. 7 is a block diagram showing an example of an structure of a display clock generator shown in FIG. 1.

### DETAILED DESCRIPTION OF THE INVENTION

Preferred embodiments of the present invention will now be described with reference to the accompanying drawings.

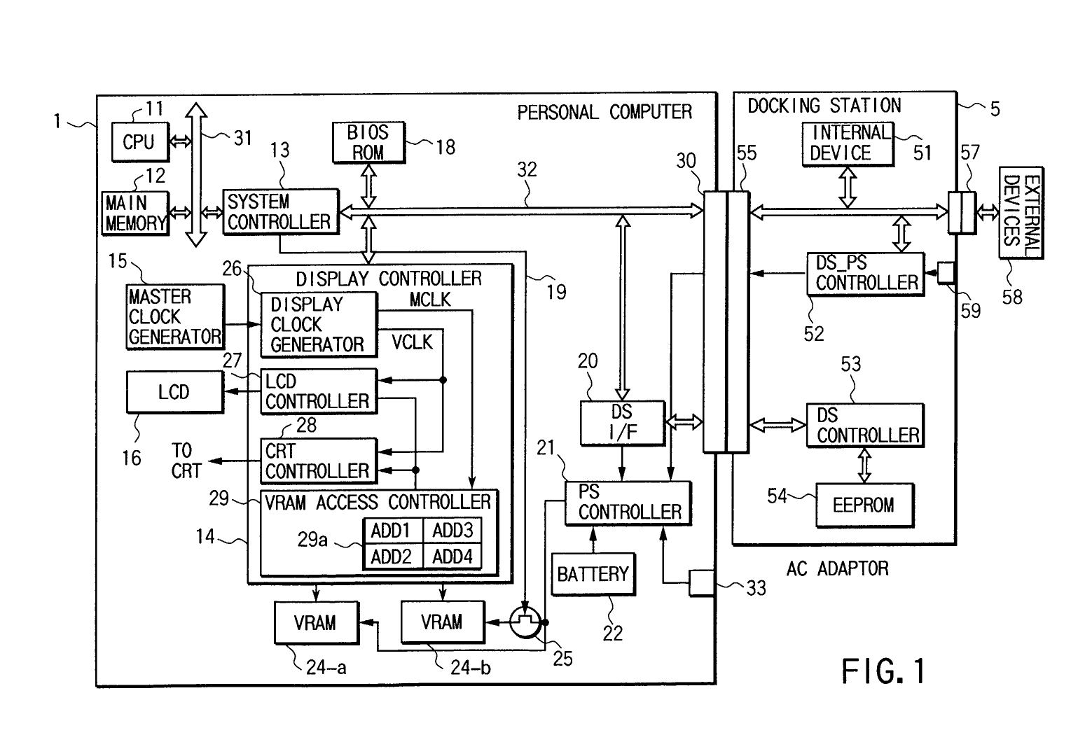

FIG. 1 presents a block diagram showing the structures of a computer (personal computer) according to a first embodiment of this invention and an expansion unit (docking station) connectable to this computer. The computer system shown in FIG. 1 comprises a personal computer 1 and a docking station 5 with various kinds of devices installed therein which expand the functions of the personal computer 1.

The personal computer 1 is a notebook type or laptop type, battery-operable portable computer. The personal computer 1 can be docked to the docking station 5 or a card dock 7 (which will be discussed later) as an expansion unit. This personal computer 1 includes a CPU 11, a main memory 12, a system controller 13, a display controller 14, a master clock generator 15, an LCD (Liquid Crystal Display) 16, a BIOS ROM (basic input/output interface) 18, a docking station interface (hereinafter called DS I/F) 20, a power supply controller 21, a battery 22, VRAMs 24-a and 24-b, an analog switch 25 and an AC adaptor 33.

A microprocessor, such as a “Pentium” manufactured by Intel Corporation, can be used for the CPU 11. This CPU 11 is connected to the main memory 12 and the system controller 13 via a processor bus 31 which has a data bus of 64 bits in width.

The main memory 12 is a memory device for storing an operating system, device drivers, an application program to be run and processed data, and comprises a plurality of DRAM (Dynamic Random Access Memory) modules.

The system controller 13 is a bridge LSI (Large Scale Integration) which bridges over a processor bus 31 and a system bus 32 like a PCI (Peripheral Component Interconnect) bus and in which hardware for controlling the generation of a system management interrupt (SMI) signal to be output to the CPU 11 at the time the personal computer 1 is docked to or removed from the expansion unit (the docking station 5 or the card dock 7).

The system controller 13 outputs a VRAM power supply control signal 19 for controlling the ON/OFF action of the analog switch 25, in accordance with the docking or non-docking of the docking station 5 to the personal computer 1 which is indicated by a docking discrimination signal to be discussed later.

The system bus 32, to which the BIOS ROM 18, the DS I/F 20 and the display controller 14 are connected, is connected to the docking station 5 via a docking connector 30. This docking connector 30 has a structure matching a docking connector 55 of the docking station 5.

The BIOS ROM 18 is constructed by a flash memory so that it can store the BIOS (Basic Input/Output System) and is programmable. Device drivers for controlling various I/O devices and a system management program are stored as the BIOS, which in this embodiment includes a program for controlling the ON/OFF action of the analog switch 25 and a program for generating the VRAM power supply control signal 19.

The DS I/F 20 is a communication unit provided for communication between the personal computer 1 and the docking station 5, and is connected to a docking station controller (hereinafter called DS controller) 53 of the docking station 5 via the docking connectors 30 and 55.

This DS I/F 20 has a function for generating the docking discrimination signal indicative of the docking or non-docking state of the docking station 5 in accordance with a signal which is output from the DS controller 53 of the docking station 5 and sending this discrimination signal to the system controller 13 via the system bus 32 as will be described later. The DS I/F 20 performs such control as to prevent an expanded device from being broken or the system from malfunction by the insertion/removal of the hot line when the personal computer 1 is hot-docked to the docking station 5 in the power on state.

This DS I/F 20 is provided with a circuit which detects if the card dock 7 to be discussed later is docked to the personal computer 1. This circuit normally monitors, for example, the voltage of a specific pin in the connector 30, which has previously been pulled up or pulled down, and determines whether or not the card dock 7 is docked, from a variation in the voltage of this specific pin. The DS I/F 20 sends the docking discrimination signal indicative of the result of this determination to the system controller 13.

The DS I/F 20 is connected to the power supply controller 21. This power supply controller 21 provides the individual units in the personal computer 1 with power supplied from the battery 22, or external power which is supplied via the AC adaptor 33 when the AC adaptor 33 is connected to the exclusive connector, or power which is supplied from the expansion unit (docking station or card dock) when the expansion unit is docked. In this respect, the power supply controller 21 has a function of detecting the amount of remaining power of the battery 22, the ON/OFF state of a reset switch, the ON/OFF state of a main power switch, if there is external power, and the ON/OFF state of an LCD panel open/close detection switch.

The DS I/F 20 may accomplish the detection of the docking of the docking station 5 by monitoring the voltage of a specific pin as in the case of detecting the docking of the card dock 7.

The display controller 14 controls the image display of the personal computer 1. The display controller 14 has a display clock generator 26, an LCD controller 27, a CRT controller 28 and a VRAM access controller 29.

The display clock generator 26 has an incorporated PLL (Phase Locked Loop) circuit. Based on a reference or master clock output from the master clock generator 15, the display controller 14 generates a memory clock MCLK for operating the VRAMs 24-1 and 24-b and a video clock VCLK for operating the LCD 16 and the CRT (Cathode-Ray Tube) which is connected as needed.

In this embodiment, the frequencies of the memory clock MCKL and the video clock VCLK are altered (increased or decreased) in accordance with the docking or non-docking of the docking station 5 to the personal computer 1. The memory clock MCLK and the video clock VCLK are increased when the personal computer 1 is docked to the docking station 5, thereby improving the resolution and the quality of the LCD 16. The memory clock MCLK and the video clock VCLK are decreased when the personal computer 1 is not docked to the docking station 5, thereby reducing the consumption of the personal computer.

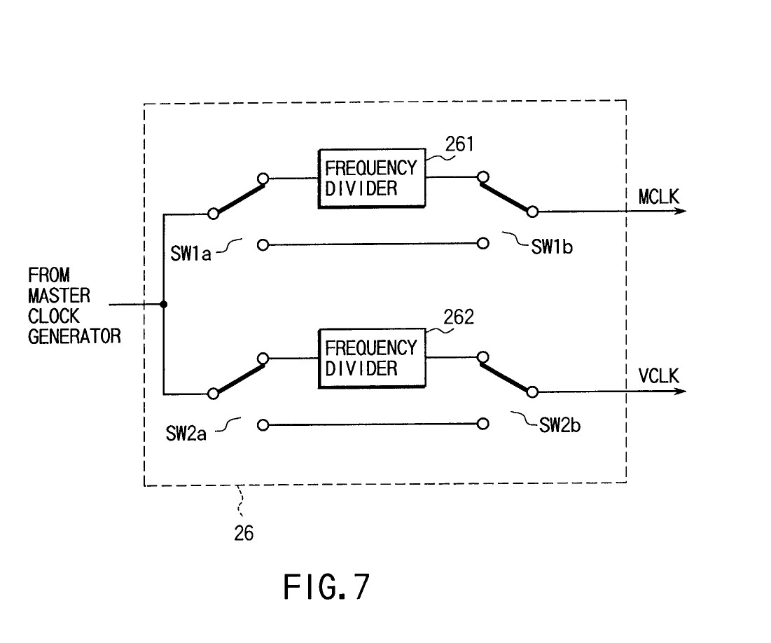

FIG. 7 shows an example of a structure of the display clock generator 26. The display clock generator 26 includes two frequency dividers 261 and 262, and four switches SW1a, SW1b, SW2a and SW2b. Each of the frequency dividers 261, 262 divides the input signal (master clock signal) at a predetermined ratio. The switches SW1a, SW1b, SW2a and SW2b are controlled according to the docking or non-docking of the docking station 5 to the personal computer 1.

More specifically, the switches SW1a and SW1b are controlled such that the master clock signal is output as the memory clock MCLK when the personal computer 1 is docked to the docking station 5, and the clock signal divided by the frequency divider 261 is output as the memory clock MCLK when the personal computer is not docked to the docking station 5. The switches SW2a and SW2b are controlled such that the master clock signal is output as the video clock VCLK when the personal computer 1 is docked to the docking station5, and the clock signal divided by the frequency divider 262 is output as the video clock VCLK when the personal computer 1 is not docked to the docking station.

In the display controller 14, the memory clock MCLK generated by the display clock generator 26 is input to the VRAM access controller 29. Based on the memory clock MCLK, the VRAM access controller 29 accesses the VRAMs 24-a and 24-b and writes image data there. This image data is supplied to the display controller 14 from the CPU 11 via the processor bus 31, the system controller 13 and the system bus 32.

At this time, the VRAM access controller 29 changes (increases or decreases) the work area of the VRAMs 24-a and 24-b in accordance with whether or not the docking station 5 is docked to the personal computer 1, and then writes image data. The VRAM access controller 29 includes an address table 29a storing addresses ADD1 to ADD4. The address ADD1 indicates a start address of the VRAM 24-a and the address ADD2 indicates a end address of the same. The address ADD3 indicates a start address of the VRAM 24-a and the address ADD4 indicates a end address of the VRAM 24-b. The CPU 11 selects either a pair of addresses ADD1 and ADD2, or a pair of addresses ADD3 and ADD4. The VRAM access controller 29 executes the memory access processing according to the addresses of the selected pair.

Specifically, when the personal computer 1 is docked to the docking station 5, the memory range that matches the memory capacity of the VRAM 24-a plus the memory capacity of the VRAM 24-b is set as the work area, whereas with the personal computer 1 not docked to the docking station 5, only the memory range that corresponds to the memory capacity of the VRAM 24-a is set as the work area.

Therefore, the VRAM 24-a is normally used irrespective of the docking or non-docking of the docking station 5 to the personal computer 1, and when the personal computer 1 is not docked to the docking station 5, image display is carried out by using only this VRAM 24-a. In view of the above, the capacity of the VRAM 24-a is set to the one (e.g., 2 Mbytes) that corresponds to the desired, minimum necessary display performance (e.g., 8-b it color display with 640×480 pixels).

Meanwhile, the VRAM 24-b is used only when the personal computer 1 is docked to the docking station 5 or only when an image is displayed with the optimal display performance. Therefore, the capacity of the VRAM 24-b is set to the one (e.g., 2 Mbytes) corresponding to the desired, optimal display performance (e.g., 24-b it color display with 1024×768 pixels).

Control on the use/non-use of the VRAM 24-b is executed by enabling/disabling power supply to the VRAM 24-b. Specifically, the ON/OFF state of the analog switch 25 provided on the power supply line from the power supply controller 21 to the VRAM 24-b is switched on the basis of the VRAM power supply control signal 19 output from the system controller 13.

With the personal computer 1 docked to the docking station 5, therefore, power from the docking station 5 is supplied to both the VRAMs 24-a and 24-b. When the personal computer 1 is not docked to the docking station 5, on the other hand, power supply to the VRAM 24-b is cut off and power from the battery 22 is supplied only to the VRAM 24-a.

The LCD controller 27 acquires image data from the VRAM 24-a and/or the VRAM 24-b in operation via the VRAM access controller 29 in accordance with the docking or non-docking of the docking station 5 to the personal computer 1, and outputs the image data to the LCD 16 in accordance with the frequency of the video clock VCLK.

The CRT controller 28 likewise acquires image data, converts it to an analog signal, and sends the signal to the CRT in accordance with the frequency of the video clock VCLK.

The AC adaptor 33 converts an AC current supplied from an external power supply to a DC current, and supplies it to the power supply controller 21. Note that this AC adaptor 33 may be provided outside the personal computer 1.

The docking station 5 will now be discussed.

This docking station 5 is an expansion unit for expanding the functions of the personal computer 1. The docking station 5 is equipped with the aforementioned DS controller 53, an EEPROM (Electrically Erasable Programmable Read-Only Memory) 54, and a power supply controller 52, and has a docking connector 55 to connect to the personal computer 1, an external connector 57 to connect to external devices 58 and an AC adaptor 59.

The docking station 5 has inside, for example, a PCI expansion card, a hard disk drive, a CD-ROM drive, etc. as internal devices 51. Further, the external devices 58 such as a PC card and MIDI (Musical Instrument Digital Interface) tone generator are connected via the external connector 57 to the docking station 5.

The DS controller 53, which performs the general control of the docking station 5, is connected to the DS I/F 20 of the personal computer 1 via the docking connectors 55 and 30. This DS controller 53 is provided with a discrimination circuit which discriminates if the personal computer 1 is docked to the docking station 5, and sends a signal indicative of the docking or removal of the personal computer 1 to or from the docking station 5 to the DS I/F 20.

The EEPROM 54 serves to store PnP information necessary for plug-and-play, such as the attribute (e.g., the address, DMA channel, etc.) of an expansion card set in the expansion slot of the docking station 5. This PnP information is read into the personal computer 1 under the control of the program in the BIOS ROM 18 when the personal computer 1 is docked to the docking station 5 or when the personal computer 1 or the docking station 5 is powered on.

The power supply controller 52 supplies the power, supplied via the internal AC adaptor 59 of the docking station 5, to the individual units of the docking station 5, and further sends that power to the personal computer 1. When the connected external device 58 is one equipped with no power supply, such as a PC card, the power supply controller 52 supplies the power to that external device 58 too.

The AC adaptor 59 converts an AC current supplied from an external power supply to a DC current, and supplies it to the power supply controller 21. It is to be noted that this AC adaptor 59 may be provided outside the docking station 5.

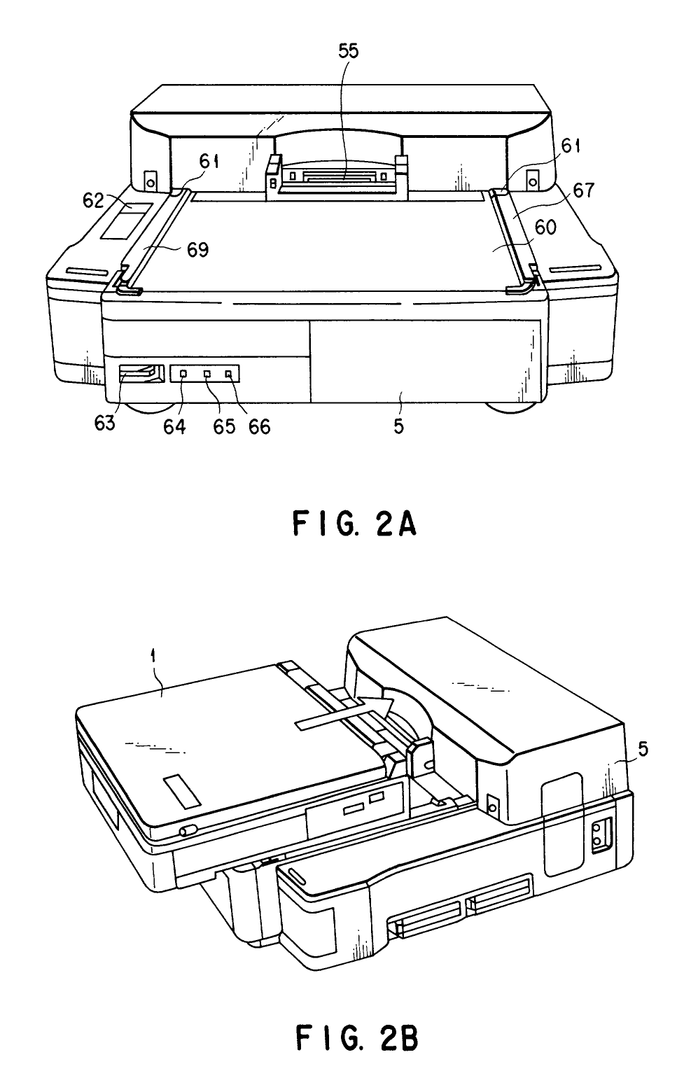

FIG. 2A shows the outline of this docking station 5 from front, and FIG. 2B shows the way the personal computer 1 is docked to the docking station 5.

The casing of the docking station 5 has a mount surface 60 for accommodating the personal computer 1. The mount surface 60 is substantially the same in size as the bottom of the body of the personal computer 1, and guide portions 67 are provided on both the right and left edges of the mount surface 60 to guide the personal computer 1 to the mount position.

Provided at the rear of each guide portion 67 is a guide pin 61 for secure docking of the personal computer 1. When the personal computer 1 is docked and connected to the docking connector 55, the guide pins 61 come above the guide portions 67 to be inserted in the respective bottom holes of the body of the personal computer 1. When the personal computer 1 is ejected in accordance with the manipulation of an operation lever 62, the guide pins 61 are so depressed as to come out of the holes.

The docking station 5 is further provided with a power switch 63, a power indicator 64, a drive-in-use indicator 65, a docking indicator 66, etc. The power indicator 64 is lit when the docking station 5 is in a power-on state. The drive-in-use indicator 65 is lit while the internal hard disk drive is being accessed. The docking indicator 66 starts blinking when the personal computer 1 is set to the mount position, and is kept lit when the docking of the personal computer 1 is completed.

The card dock 7 will be discussed below.

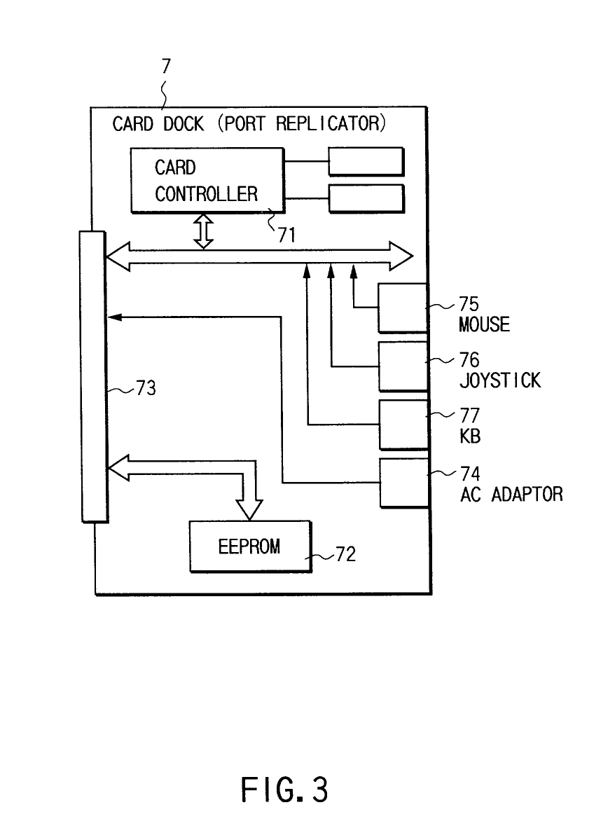

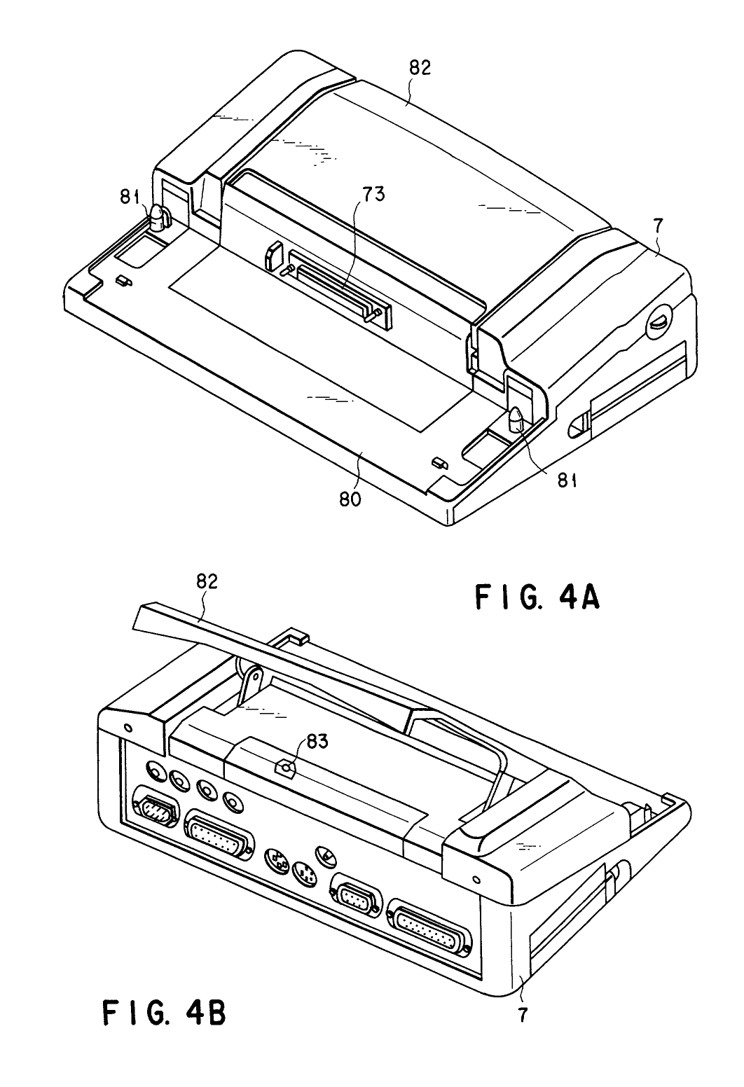

FIG. 3 is a block diagram showing the structure of the card dock 7, and FIGS. 4A and 4B are perspective views showing the card dock 7 as seen from front and back, respectively.

As mentioned earlier, the personal computer 1 can be docked to the docking station 5 as an expansion unit, and also to the card dock 7 as an expansion unit. That is, the card dock 7 is also an expansion unit removable from the body of the personal computer 1.

The card dock 7 has a card dock controller 71, an EEPROM 72, a connector 73 and an AC adaptor 74. Provided at the back of the card dock 7 are various connectors like a mouse connector 75, a joystick connector 76 and a keyboard connector 77. The block diagram of FIG. 3 shows only those mentioned connectors for the sake of descriptive simplification.

The card controller 71 controls PC cards which conform to the card bus of the PCMCIA (Personal Computer Memory Card International Association).

The EEPROM 72 stores PnP information necessary for plug-and-play, such as the attribute of the PC card that is set in the PC card slot of the card dock 7. This PnP information is read from the EEPROM 72 by the DS I/F 20 under the control of the system BIOS in the BIOS ROM 18 when the personal computer 1 is docked to the card dock 7 or when the personal computer 1 or the card dock 7 is powered on.

The connector 73 matching the connector 30 of the personal computer 1 is connected to this connector 30 when the personal computer 1 is docked to the card dock 7.

The AC adaptor 74 converts an AC current supplied from an external power supply to a DC current, and supplies it to the power supply controller 21 of the personal computer 1 via those connectors 73 and 30.

With reference to FIGS. 4A and 4B, the structure of the casing of the card dock 7 will be described below.

As shown in FIG. 4A, the casing of the card dock 7 has a mount surface 80 for accommodating the personal computer 1. The mount surface 80 is substantially the same in size as the bottom of the body of the personal computer 1, and guide pins 81 are provided at the rear ends of the right and left edges of the mount surface 80. Those guide pins 81 are put in the respective bottom holes of the personal computer 1 to guide the personal computer 1 to the mount position so that the connectors 30 and 73 of the personal computer 1 and the card dock 7 are connected together. The guide pins 81 move between the front position and the back position on the mount surface 80 in responsive to the manipulation of a manual handle 82. Specifically, when the manual handle 82 is lifted up by a user, the guide pins 81 are moved forward of the mount surface 80, and when the manual handle 82 is pushed down as illustrated, the guide pins 81 are moved rearward of the mount surface 80.

In docking the personal computer 1 to the card dock 7, first, the manual handle 82 is lifted up and the bottom holes of the personal computer 1 are fitted over the guide pins 81 in this state. As the manual handle 82 is pressed down, the guide pins 81 guide the body of the personal computer 1 to the mount position of the card dock 7 at which the connectors 30and 73 are connected together. To remove the personal computer 1 from the card dock 7, the manual handle 82 is lifted up so that the personal computer 1 is pushed forward by the guide pins 81, disconnecting the connectors 30 and 73 from each other.

FIG. 4B is a perspective view when the card dock 7 is seen from the back. This figure shows the manual handle 82 lifted up. A detection switch 83 provided on the casing of the card dock 7 serves to detect the UP/DOWN action of the manual handle 82.

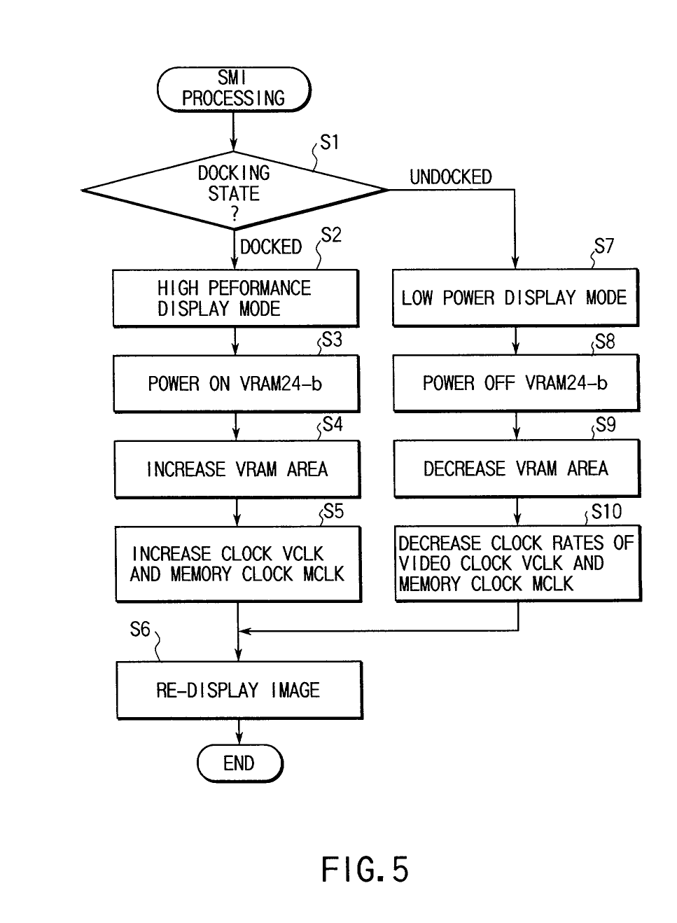

Referring to the flowchart in FIG. 5, a description will now be given of an SMI process for the display control system in accordance with the docking state of an expansion unit.

This SMI process is executed as the personal computer 1 is docked to an expansion unit (the docking station 5 or the card dock 7) or is removed from the expansion unit.

When the expansion unit is the docking station 5, the DS I/F 20 generates the docking discrimination signal in accordance with the signal that is sent from the DS controller 53 of the docking station 5, and sends this discrimination signal to the system controller 13 via the system bus 32. In accordance with a change in the received signal, for example, from “H” to “L” or from “L” to “H,” the system controller 13 sends an SMI signal to the CPU 11 in response to the change. That is, the system controller 13 outputs an SMI signal according to the docking of the docking station 5 and an SMI signal according to the removal of the docking station 5. The data indicating the factor of the SMI signal generation is stored in a register (not shown) of the system controller 13. The CPU 11 receives the SMI signal via the processor bus 31 and executes an SMI processing routine for switching between the display performances recorded in the BIOS ROM 18.

When the expansion unit is the card dock 7, the DS I/F 20 detects a change in the voltage of the specific pin of the connector 30 to determine the docking to the card dock 7, and generates and outputs the docking discrimination signal in accordance with the determination result. As in the case of the docking station 5, the system controller 13 generates an SMI signal in accordance with a change in the docking discrimination signal and the CPU 11 executes the SMI process according to this SMI signal.

Upon reception of the SMI signal, the CPU 11 determines first if the expansion unit is docked or removed. This determination is made by discriminating if the SMI signal produced by the system controller 13 indicates the docking process or the removal process (step S1).

When the personal computer 1 is docked to the expansion unit, a process is initiated to switch the display mode to a high performance display (high power) mode for image display at the optimal display performance set in the display control system (step S2).

First, the system controller 13 outputs the VRAM power supply control signal 19 in such a way as to switch the analog switch 25 on. This permits the power from the battery 22 to be supplied to the VRAM 24-b via the power supply controller 21, enabling the VRAM 24-b (step S3).

Then, the system controller 13 informs the display controller 14 of the docking of the personal computer 1 to the expansion unit. Accordingly, the VRAM access controller 29 in the display controller 14 increases the work area of the VRAMs 24-a and 24-b (step S4). Specifically, the VRAM access controller 29 widens the memory area to be used from the range of the memory area of the VRAM 24-a alone to the range that includes the memory area of the VRAM 24-b. Further, the display clock generator 26 sets the video clock VCLK and the memory clock MCLK to the highest frequency among available frequencies, i.e., the highest clock rate and outputs the clocks (step S5).

Then, the display controller 14 redisplays an image on the LCD 16 or CRT in accordance with the set high performance display mode (step S6). As a result, the image display is carried out with the optimal display performance that brings about the maximum performances of the display controller 14 and the VRAMs 24-a and 24-b. Image display thereafter is executed in accordance with this high performance display mode.

In this case, although the power consumptions of the display controller 14 and the VRAMS 24-a and 24-b are increased, the power from the battery 22 is not consumed because the personal computer 1 operates on the power that is supplied from the AC adaptor connected to the docking station 5.

When the personal computer 1 is undocked from the expansion unit, a process is initiated to switch the display mode to a low power display (low performance display) mode for image display with suppressed consumption of the power from the battery 22 (step S7).

First, the system controller 13 controls the VRAM power supply control signal 19 to switch off the analog switch 25. This cuts off power supply to the VRAM 24-b from the battery 22, thus disabling the VRAM 24-b (step S8).

Then, the system controller 13 informs the display controller 14 of the undocking of the personal computer 1 from the expansion unit. The VRAM access controller 29 in the display controller 14 decreases the work area of the VRAMs 24-a and 24-b (step S8). Specifically, the VRAM access controller 29 sets the memory area to be used to the range of the memory area of the VRAM 24-a alone from the range that includes the memory area of the VRAM 24-b.

Further, the display clock generator 26 sets the video clock VCLK and the memory clock MCLK to a low frequency in available frequencies (e.g., about ⅓ of the frequency in high performance display mode), i.e., a low clock rate and outputs the clocks (step S9).

Then, the display controller 14 redisplays an image on the LCD 16 or CRT in accordance with the set low power display mode (step S6). Thereafter, image display is carried out with the low power display mode. As a result, the image display performance of the personal computer 1 is suppressed and the display controller 14 and the VRAM 24-a operate on lower power than that in the high performance display mode. This reduces consumption of the power from the battery 22 to allow the personal computer 1 to operate for a long period of time even with the battery 22 alone.

According to the computer system of the first embodiment, as apparent from the above, the image display performance of the personal computer 1 is controlled in accordance with whether or not an expansion unit is docked to the personal computer 1. With the personal computer 1 docked to the expansion unit, image display is executed with the optimal display performance in high performance display mode, and with the personal computer 1 not docked to the expansion unit, the mode is set to the low power display mode to reduce the display performance and image display is carried out in such a way as not to consume the power from the battery 22.

When the personal computer 1 is not docked to the expansion unit, particularly, power supply to the VRAM 24-b from the battery 22 is cut off to permit power to be supplied only to the VRAM 24-a, and the VRAM access controller 29 sets only the memory area of the VRAM 24-a as a work area accordingly, thus reducing the overall power dissipation of the VRAMs 24-a and 24-b.

The power dissipation in the personal computer 1 when power is supplied only to the VRAM 24-a becomes approximately a half of what is consumed when power is supplied to a single VRAM which has a capacity equivalent to the capacity of the VRAM 24-a plus the capacity of the VRAM 24-b.

When the personal computer 1 is not docked to the expansion unit, the display clock generator 26 outputs the low-frequency memory clock MCLK for operating the VRAM 24-a, so that the processing speed of the VRAM 24-a is decreased to further reduce the power consumption in the VRAM 24-a.

Further, when the personal computer 1 is not docked to the expansion unit, the display clock generator 26 outputs the low-frequency video clock VCLK for operating the LCD 16 or CRT, so that the processing speed of the display controller 14 is lowered to reduce the power consumption in the display controller 14 too.

As apparent from the above, when the personal computer 1 is not docked to the expansion unit, the display controller 14 and the VRAMs 24-a and 24-b can operate on low power. It is therefore possible to enhance the overall power reduction effect of the personal computer 1 and operate the personal computer 1 for a long period of time on the power from the battery 22 alone.

A second embodiment of this invention will now be described.

This second embodiment is characterized by its function to switch between the high performance display mode and low power display mode in the first embodiment in accordance with whether or not external power is supplied.

Since the structures and appearances of a personal computer according to the second embodiment and an expansion unit (docking station or card dock) to which this personal computer is connectable are the same as those of the first embodiment, their detailed description will be omitted and the differences will be discussed by referring to same or like reference numerals as used in the first embodiment.

In this second embodiment, the power supply controller 21 of the personal computer 1 has a function to determine if external power is supplied.

There are three supply paths for external power; the first path along which external power is supplied via the AC adaptor 33 of the personal computer 1, the second path along which external power is supplied via the power supply controller 52 and connectors 55 and 30 from the AC adaptor 59 of the docking station 5, and the last path along which external power is supplied via the connectors 73 and 30 from the AC adaptor 74 of the card dock 7. The power supply controller 21 determines if external power is supplied, regardless of any of those paths.

The power supply controller 21 sends a determination signal indicative of the presence/absence of external power to the DS I/F 20. The DS I/F 20 sends the received determination signal to the system controller 13 via the system bus 32. In accordance with a change in the received signal, for example, from “H” to “L” or from “L” to “H,” the system controller 13 sends an SMI signal according to the change to the CPU 11. In other words, the system controller 13 outputs an SMI signal originating from the initiation of the supply of the external power and an SMI signal originating from the inhibition of the supply of the external power, as different SMI signals. The CPU 11 receives the SMI signal via the processor bus 31 and executes an SMI processing routine for switching the display performances from one to the other.

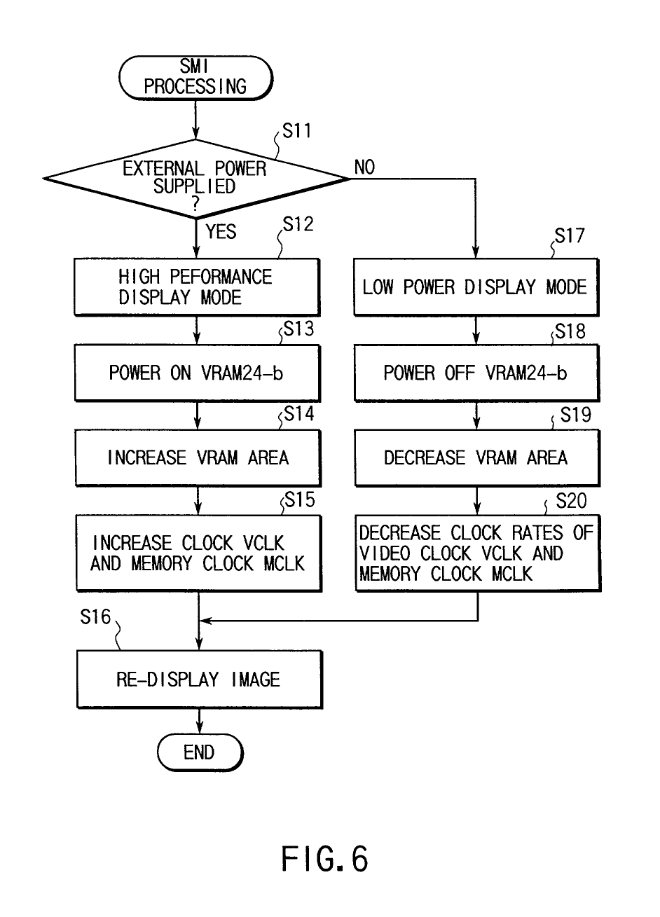

This SMI processing routine is illustrated in FIG. 6.

When receiving the SMI signal, the CPU 11 first determines whether the supply of the external power is initiated or is stopped. This determination is made by discriminating whether the SMI signal generated by the system controller 13 indicates the start of power supply or the stop of power supply (step S11).

Processes of steps S12 to S16 are executed when power supply is started, and processes of steps S17 to S20 and S16 are executed when power supply is stopped. As those processes are the same as those illustrated in FIG. 5, their detailed description will be omitted.

According to the second embodiment, as apparent from the above, the image display performance of the personal computer 1 is controlled in accordance with whether or not there is external power supplied to the personal computer 1. That is, when external power is supplied to the personal computer 1, image display is carried out with the optimal display performance in high performance display mode, and when no external power but only the power from the battery 22 is supplied to the personal computer 1, the display performance is suppressed in the low power display mode so that image display is carried out in such a way as not to consume the power from the battery 22.

It is therefore possible to accomplish the same advantages as those of the first embodiment discussed earlier.

Although the first and second embodiments have been discussed with reference to the case where a process of powering on or off the VRAM 24-b, a process of changing the work area of the VRAMs 24-a and 24-b, a process of changing the frequency of the memory clock MCLK and a process of changing the frequency of the video clock VCLK are all executed in accordance with the docking/undocking of an expansion unit to the personal computer 1, some modification may be made to execute only one of those processes or a combination of some of them.

While the first and second embodiments have been discussed with reference to the case where image display is automatically carried out in low power display mode when no expansion unit is docked to the personal computer 1, some modification may be made to allow a user to switch the mode to the high performance display mode as desired even when the personal computer 1 is not docked to the expansion unit.

Further, various processes in the first and second embodiments may be performed in accordance with a timer interrupt.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A computer comprising:
a display for displaying an image;
detection means for detecting start and stop of supply of external power to said computer; and
display control means for controlling image display on said display, a display performance of said display control means being altered in accordance with a result of detection by said detection means.

2. The computer according to claim 1, wherein said display control means operates in accordance with a clock and alters a clock rate of said clock in accordance with said result of detection.

3. The computer according to claim 1, wherein said display control means has a memory portion for storing an image to be displayed on said display and alters a size of a work area of said memory portion in accordance with said result of detection.

4. The computer according to claim 3, wherein said memory portion has a first memory and a second memory, and said display control means alters said size of said work area in such a way as to use said first memory and said second memory when said detection means detects start of supply of external power and alters said size of said work area in such a way as to use only one of said first memory and said second memory when said detection means detects stop of supply of external power.

5. The computer according to claim 4, further comprising power supply means for supplying drive power to said first memory and said second memory when said detection means detects start of supply of external power, and supplying drive power to only one of said first memory and said second memory to be used when said detection means detects stop of supply of external power.

6. The computer according to claim 1, further comprising an AC adaptor for receiving said external power and supplying said input power to said power supply means.

7. The computer according to claim 1, wherein said computer is connectable to an expansion unit and said power supply means receives said external power via said expansion unit.

8. A computer connectable to an expansion unit, comprising:
a display for displaying an image;
detection means for detecting docking and undocking said computer to and from said expansion unit; and
display control means for controlling image display on said display, a display performance of said display control means being altered in accordance with a result of detection by said detection means.

9. The computer according to claim 8, wherein said display control means operates in accordance with a clock and alters a clock rate of said clock in accordance with said result of detection.

10. The computer according to claim 8, wherein said display control means has a memory portion for storing an image to be displayed on said display and alters a size of a work area of said memory portion in accordance with said result of detection.

11. The computer according to claim 10, wherein said memory portion has a first memory and a second memory, and said display control means alters said size of said work area in such a way as to use said first memory and said second memory when said detection means detects docking of said expansion unit and alters said size of said work area in such a way as to use only one of said first memory and said second memory when said detection means detects undocking of said expansion unit.

12. The computer according to claim 11, further comprising power supply means for supplying drive power to said first memory and said second memory when said detection means detects docking of said expansion unit, and supplying drive power to only one of said first memory and said second memory to be used when said detection means detects undocking of said expansion unit.

13. The computer according to claim 12, wherein said power supply means receives external power via said expansion unit, and generates drive power for said computer.
